(19) United States
(12) Patent Application Publication
(10) Pub. No.: US 2002/0123984 A1
(43) Pub. Date: Sep. 5, 2002

(54) Dynamic query of server applications

(76) Inventor: Naveen Prakash, Foster City, CA (US)

Correspondence Address: McAndrews, Held & Malloy, Ltd., 500 W. Madison St., 34th Floor, Chicago, IL, 60661, US

(21) Appl. No.: 10/055,505

(22) Filed: Oct. 26, 2001

Related U.S. Application Data
(60) Provisional application No. 60/164,021, filed on Aug. 23, 1999.

(51) Int. Cl. G06F 7/00

(52) U.S. Cl. 707/1

(57) ABSTRACT

A framework for the creation and execution of a dynamic query (or recommended content) that includes a web-based interface for a business manager or administrator to query data in applications running on a server system. Graphical user interface screens will allow a user to create leaf conditions (or expressions), and to logically join the leaf conditions into more complex conditions. The conditions are then collectively joined into a query. The query will be persisted into database tables by saving the Where Clause in XML. The query can be executed using a adapter-connector framework provided by a host platform (i.e., the referenced Asera platform). Thereafter, the results will be displayed to the end user.

### RELATED APPLICATIONS

This application is related to the following—U.S. Provisional patent application having Serial No. 60/164,021, entitled “Method and Apparatus to Provide Custom Configurable Business Applications from a Standardized Set of Components,” filed Aug. 23, 1999; Utility patent application having Ser. No. 09/440,326, entitled “Method for Providing Custom Configurable Business Applications from a Standardized Set of Components,” filed Nov. 15, 1999; Utility patent application having Ser. No. 09/439,764, entitled “Apparatus to Provide Custom Configurable Business Applications from a Standardized Set of Components,” filed Nov. 15, 1999; Utility patent application having Ser. No. 09/658,415, entitled “Method For Developing Custom Configurable Business Applications,” filed Sep. 8, 2000; Utility patent application having Ser. No. 09/658,416, entitled “Integrated Design Environment for a Commerce Server System,” filed Sep. 8, 2000; Utility patent application having Ser. No. 09/697,271, entitled “Method for Providing Template Applications for Use by a Plurality of Modules,” filed Oct. 25, 2000; Utility patent application having Ser. No. 09/691,461, entitled “Method and Apparatus for Providing News Client and Server Architecture and Protocols,” filed Oct. 17, 2000; Utility patent application having Ser. No. 09/684,491, entitled “Adapter and Connector Framework for Commerce Server System,” filed Oct. 4, 2000; Utility patent application having Ser. No. 09/702,148, entitled “E-Commerce Application Built Using Workflows on a Workflow Engine and Methods Thereof,” filed Oct. 30, 2000; Utility patent application having Ser. No. 09/702,290, entitled “Presentation Layer for Business Application Development and Methods Thereof,” filed Oct. 30, 2000; Utility patent application having Ser. No. 09/702,291, entitled “Scalability, Availability, and Management Features For Business Commerce Server,” filed Oct. 30, 2000; Utility patent application having Ser. No. 09/706,304, entitled “Content Management Framework for Business Commerce Server,” filed Nov. 3, 2000; and Utility patent application having Ser. No. 09/727,912, entitled “Workflow Driven Rules-Based Generation of Personalizable Web Page,” filed Nov. 28, 2000; Utility patent application having Ser. No. 09/893,134, entitled “Menu Infrastructure Apparatus and Method,” filed Jun. 27, 2001; Utility patent application having Ser. No. 09/925,241, entitled “Rule Based Personalization Framework,” filed Aug. 8, 2001,—each of which is hereby incorporated by reference in their entirety.

### FIELD OF THE INVENTION

The present invention provides a web-based interface for a business manager or administrator to query data from a variety of applications running on a platform or server system.

### BACKGROUND OF THE INVENTION

Asera Commerce Server.

The prior referenced applications provide for methods and apparatuses for creating custom configurable business or channel applications from a standardized set of components. More specifically, the referenced invention(s) allow each business to select from a set of applications, customize that set of applications, and/or develop new customized applications from a set of development components. The prior applications provide for a server based method wherein best-of-breed services and/or applications are integrated in a seamless fashion and offered to enterprise businesses which develop customized business service applications through using the system. The server device is previously (and hereafter) referred to as the Asera Commerce Server (ACS).

The ACS includes a Commerce Server that provides a core set of technology (or application) services. A unique architecture and framework are provided by the Commerce Server, which facilitates development and use of customized applications. Most interactions with external systems or users are managed as Business Objects. The service application code is maintained separate from the data. This enables the system to quickly include (and/or change) new business processes or technology components without having to write substantial amounts of new code. The business result is more rapid customer deployments and/or modifications that are customized to include (if desired) the proprietary or competitive business practices of a contracting company.

The ACS can be viewed as a form of ASP (Application Service Provider). An ASP is generally an outsourcing business model. The ASP business model requires an open and extendable architecture that allows a system to implement a customer specific business solution in a short period of time. The ACS takes best-of-breed applications and incorporates them into one integrated solution to provide the ASPs. The architecture is scalable and extensible. A customized business (or channel) application solution is built for each enterprise company. The solution uses a “modular” or step-wise or “plug-and-play” approach towards building new applications. An enterprise company can then quickly acquire a turn-key e-commerce solution to automate their channel relationships. The system presents little (or no) risk for the enterprise company because a solution is built by the present system. The costs of undertaking such a development exist as a fixed development cost of the system. Any resulting customized solutions are implemented in considerably less time than previous systems. The enterprise company might pay for the application services on a cost per transaction or a fixed-fee basis.

The ACS is used to capture the particularized (or specific) business processes for a given customer, and these business processes are converted into a set of customized applications. The ACS uses business steps and rules to construct the application. The objects are data representations. The steps are business operations with a defined set of input and output ports, with each port also having a defined set of parameters. The business rules are used to capture customer specific business practices. A unique tool that employs a graphical user interface (GUI) allows a developer to arrange various steps (or composite steps) into business processes or workflows. The tool provides library catalogs of steps to be applied to the various objects. The connections between steps are also verified as correct. A graphical display of the business process is shown, and rules can thereafter be applied to provide further customization by conditionally tagging certain points. Hence, to create a business process (or application) for any given business, tools are provided which allow modules (or steps) to be plugged or dropped into the potential process. The steps can be moved or the connections modified. An initial person-to-person (or other type of) interview with the business (or customer) can be used to produce the framework for arranging the steps according to the needs of that particular business (i.e., customized routines). The modular aspect of the present system allows this to be done—and modifications made—in a relatively quick fashion. For instance, if a process has been created, but the customer wants it to behave in two different manners, then certain rules can be applied to provide the desired results, depending upon conditional triggers that can be associated with the underlying Business Objects.

Querying Application Data.

Once an application is implemented on a server system (such as the ACS configuration described above), it is often useful (and necessary) to query information that might exist across a variety of applications running on the server system. In prior implementations, combinations of the view data objects (VDOs) and associated query definitions are used to allow the end user to create and execute a query without specific knowledge of the underlying process by the user. One problem with this approach is that query definitions are defined at the time of activation (before the site goes live), and therefore cannot change during runtime. This prior approach therefore provides a static way of interpreting a user's input. This static approach is sufficient for search forms in most applications, but is not powerful enough to execute a generalized query.

Certain drawbacks associated with this prior approach might be demonstrated by way of a specific example. For instance, for a “Marketing Collateral Application”, there are generally two ways of displaying related collaterals. One way is to store the primary keys of related collaterals in one of the multiple cardinality attributes of a collateral business object. This would require, however, some kind of tool that finds out all of the related collaterals at the time of creation of a new collateral. The tool may or may not require human intervention. If the content is published through a third-party content management system, there may not be a tool for performing such a task. The other way could be to use some heuristics to find related content at runtime, i.e., when the user is looking at some content. The heuristics might be statically defined at the time of activations, but this could prove to be very problematic if the heuristics need to change.

Instead, what is needed in the field is a system or device for allowing the business manager and/or system administrators to define such heuristics through a web interface. The system or device would allow for the dynamic creation of queries through a browser based GUI. Content would then be retrieved from a variety of applications or data sources existing on the system and thereafter displayed to the user.

### SUMMARY OF THE INVENTION

The present invention provides a client (including web-based) interface for a business manager or administrator to query data in applications running on a server system. Queries constructed through the web interface can be used for displaying related content (like collaterals), up-sell and cross-sell of products, promotions, etc. Queries are persisted in database tables. Each row corresponds to a single query and will store condition tree (“where” clause) in XML, sort operand, sort operator, display attributes, etc. Queries are executed using adapter-connector framework provided by a host platform (i.e., the Asera platform). Thereafter, the results will be displayed to the end user.

There are two types of queries—abstract and non-abstract. Abstract queries will have variables in their conditions, and hence cannot be executed at the time of the query construction. Such queries can be used in workflows to get recommended content after plugging in values for the variables. An example of an abstract query would be a query created by an administrator to display a list of articles related to—for instance—a marketing collateral document (or the like) that the user is currently viewing. The non-abstract queries do not have any variables and can be executed at the time of the construction of the query. The non-abstract query can then be used like a search form to query all of the data in the Asera (or like) environment. An example of this type would be a query to get a list of all the job postings after a certain date. The latter type can be used to define data groups like user community, data entitlement, family of products, etc.

Presentation of the content can be done using the Personalization Rule (PR) tags associated with Rule Based Personalization (see reference incorporated above), or by using standard micro-templates in the workflow of the application. The decision to use either one will depend on associated business requirements and will be decided at the time of activation. In other words, the wire frame will contain PR tags for attaching any rule to it, and/or micro-templates for rendering the content generated in the workflow. To avoid confusion at the time of upgrades, these micro-templates and/or PR tags cannot generally be removed from one release to another. The micro-templates or PR tags can removed, or new ones added, at the time of activations.

In each case, the query for recommended content will need to be created. The Recommended Content application will be used for maintaining these queries. This includes searching, creating, editing, copying and deleting queries. If used with RBP as an action type, the Recommended Content RBP action configuration screen will provide a hyper link for creating new queries. Both schemes eventually lead to the same set of recommended content creation screens, as they invoke the same Interactive Composite Step (ICS).

Generally, there will exist a public ICS for creating, editing, and copying queries. Another ICS will allow the business manager to choose a named query for configuring RBP action of the type recommended content. A public Functional Composite Step (FCS) will execute the query and will optionally take a list of parameters. These queries define a set of data and can be used by any application that requires runtime configurable data sets. One can create and modify a data set by creating and editing a query respectively. The data set can be accessed by using the mentioned FCS.

Example scenarios that can be used with the recommended content include, but are not limited to: (i) Displaying “recommended topics” that list articles related to a Marketing Collateral document (or the like) that the user is currently viewing; (ii) Listing applicable Cross-Sell and Up-Sell items for a particular product in the Product Catalog; (iii) In association with RBP, configuring an action of a rule. An example could be to display promotions related to a convertible car for a user in a sunny climate. The user group manager of the RBP can develop the “if-part”, while the query associated with the action for this rule will fetch and display the appropriate promotions.

Accordingly, one aspect of the present invention is a method for creating information queries to be used for locating and displaying information from a variety of applications running on a server system, the method comprising: interactively displaying at least one browser-based graphical user interface screen; creating at least one condition in response to prompts from the graphical user interface screens; prompting for the logical combination of the conditions into a query; prompting for the logical combination of the queries into a complex query; persisting the resulting query into associated database tables; executing the query; and displaying the results of the query to the end user.

Still another aspect of the present invention provides for a graphical user interface that provides for creating the conditions for a Where Clause of a query in any form, the interface comprising: at least one interactive screen to allow the user to select query leaf conditions; at least one interactive screen to allow the user to logically nest and join query leaf conditions; at least one interactive screen to allow the user to change the nesting and joining of query leaf conditions; and at least one interactive screen to allow the user to repeat certain screens, thereby adding more leaf conditions, and joining them into a more complex condition, whereby the resulting query is saved in a persistent storage for execution of the query, and for display of the query results.

The above and other features, aspects and advantages of the present invention will become apparent from the following descriptions and attached drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIGS. 1A-1D are representative block diagrams, according to one aspect of the present invention, showing the formation of various leaf-level query conditions.

FIG. 2 includes at least one representative interactive screen, according to one aspect of the present invention, showing the processes of creating and searching for recommended content.

FIG. 3A includes at least one representative interactive screen, according to one aspect of the present invention, showing the process for creating recommended content details.

FIG. 3B includes at least one representative interactive screen, according to one aspect of the present invention, showing the process for entering still other attributes of a query.

FIG. 4 includes at least one representative interactive screen, according to one aspect of the present invention, showing the process for adding new conditions.

FIG. 5 includes at least one representative interactive screen, according to one aspect of the present invention, showing the process for saving the query.

FIG. 6 includes at least one representative interactive screen, according to one aspect of the present invention, showing the process for creating a complex condition.

FIG. 7 includes at least one representative interactive screen, according to one aspect of the present invention, showing the process for adding still another condition to the query.

FIG. 8 includes at least one representative interactive screen, according to one aspect of the present invention, showing the process for logically combining two conditions into the resulting query.

FIG. 9 includes at least one representative interactive screen, according to one aspect of the present invention, showing the process for editing a condition.

FIG. 10 includes at least one representative interactive screen, according to one aspect of the present invention, showing the process for finishing editing a condition.

FIG. 11 includes at least one representative interactive screen, according to one aspect of the present invention, showing the process for ANDing remaining conditions.

FIG. 12 includes at least one representative interactive screen, according to one aspect of the present invention, showing the process repeating logical operations on conditions to create a complex query.

FIG. 13A includes at least one representative interactive screen, according to one aspect of the present invention, showing two conditions—a leaf condition and a non-leaf condition.

FIG. 13B includes at least one representative interactive screen, according to one aspect of the present invention, showing the result of splitting the non-leaf condition of FIG. 13A.

FIG. 14 is a block diagram, according to one aspect of the present invention, showing interaction of the query.

FIG. 15 is a block diagram, according to one aspect of the present invention, showing the process or data flow for the dynamic query.

### DESCRIPTION OF THE PREFERRED EMBODIMENTS

The present invention provides a framework for construction of queries. This framework is used to provide a web based interface for business managers or administrators to create queries through a browser based GUI. The query is then persisted into database tables by saving its different attributes like the condition tree as serialized XML, sort operand and operator, display attributes, etc. The query is thereafter executed by transforming it into some native representation such as adapter-connector framework provided by the Asera platform. The principles contained herein are readily applicable to other types of frameworks or server platforms. The results are thereafter displayed to the end user as required.

In general, Recommended Content, RBP, and User Management will use and share some common constructs for construction of condition tree. Note that this tree is a content condition for RBP, and a query condition for Recommended Content. Either of these is built when the business manager/administrator uses the screens provided to build the conditions. Common constructs might also be shared for specifying user-friendly names for business object attributes that are displayed in the drop-downs in the GUI, and for accessing path expressions (actual instances of business objects). A query constructed via the Recommended Content GUI will include attributes like the return business object type, sort operand and operator, maximum size of the results, and the query condition (i.e., similar to the “where” clause in SQL).

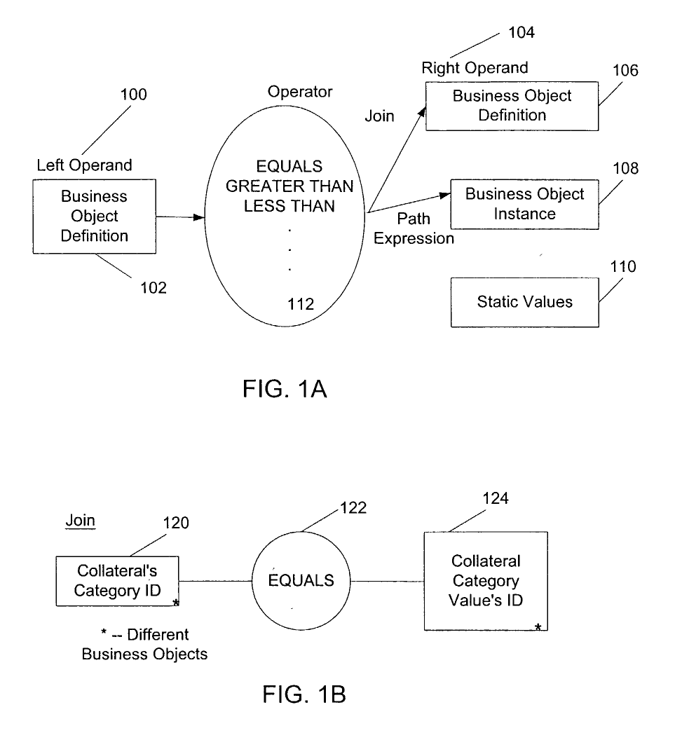

The interaction flow for constructing the query condition will be similar to that for creation of the content condition in RBP. It will differ, however, in the operands and operator used to construct the leaf conditions or the binary expression. FIG. 1A shows an example of such. For a query condition, the left operand 100 will specify the business object definition 102 (class name), while the right operand 104 could either be a business object definition 106 (for join), business object instance 108 (for path expression), or a static value 110. The operator 112 is shown to include arithmetic operators such as Equals, Greater Than, Less Than, and so forth.

FIG. 1B shows an example of join, wherein the Collateral's Category Id 120 is set equal (via the operator 122) to the right operator Collateral Category Value's Id 124, where the Collateral used in the left operand and Collateral Category Value used in the right operand are two different business object definitions.

FIG. 1C shows an example of the use of a path expression. In this example, the left operand of Collateral's type 130 is set equal (via the operator 132) to the Displayed Collateral's Type 134, where the value for the right operand of the type path expression will be available when the user is looking at some Marketing Collateral.

An example of the use of a static value is shown in FIG. 1D. Here the expression becomes Collateral's Category (140) equals (142) “Sales (144),” where the right operand is a static value.

There can be a large number (or forest) of logical trees created during the process of condition creation. At the end, all of the trees should be combined into one tree using logical operators (i.e., AND, OR, etc.). The ICS for construction of a condition will store this forest in certain workflow variables. A Java class for implementing the forest will support joining (ANDing, ORing) and splitting of these trees. The condition will be saved in XML and will capture the way it was constructed (the order in which it was joined) in order to aide in future editing. In the end, query attributes will be stored in business objects related to Recommended Content. The primary key (i.e., a unique canonical id) for this query will be used to get the content for use in some workflow (i.e., an action for RBP, or the workflow for showing content details).

A business object will be used to store all of the information about the query, including for instance the displayed content type, the Where Clause, and so forth. In XML, a query language (like XML-QL) has a construct clause either preceded or followed by an optional Where clause. An example might be: Query::=((<WHERE>Where(<CONSTRUCT>Construct)?)|(<CONSTRUCT>Construct(<WHERE>Where)?)). A missing Where clause is regarded as “true.” Each construct clause and the nested query blocks inherit the conditions of the Where clauses of its containing blocks. A Where clause is a sequence of TagPattern and Predicate expressions. A TagPattern expression attempts to bind variables to document fragments in the specified Datasource; one set of values is produced for each document fragment that matches the TagPattern. Predicates apply boolean predicates to bound variables. An example of a Where clause includes: Where::=Condition(<COMMA>Condition). The Condition in most of these query languages is a parenthesized boolean expression. The present invention provides an XML representation of the condition tree required for tagging different operand types (for join, path expression or static values). It also needs to capture the way condition tree was constructed through the web based GUI. This condition tree is saved as one of the attributes of the business object (ContentDefinition) used for storing the query. A thin transformation layer can convert this representation to any required by the underlying querying mechanism (like adapter-connector framework provided by the ACS platform).

A Declarative Object Cache and BaseDBAdapter will be used for this business object. The top level ICS will provide an entry point for administration of queries, configuration of actions of the type Recommended Content in RBP, and rendering of PR tags with business object iterator. A public FCS can be used in any workflow for getting results of named queries. Workflow for displaying Marketing Collateral Details will similarly use a query to display links to related collaterals.

An example is next shown for creation of a query for displaying related collaterals on the collaterals details page in a representative Marketing Collateral application. The collateral business object definition and the displayed collateral will be used for the construction of conditions. For instance, the content administrator might define related collateral as all collateral that contains the displayed collateral's keywords, and also belong to the same family or category as that of the displayed collateral. The constructed query might have three expressions or leaf conditions in its tree:

1. Collateral's Description CONTAINS Displayed Collateral's Description.

2. Collateral's Category EQUALS Displayed Collateral's Category.

3. Collateral's Type EQUALS Displayed Collateral's Type.

The administrator can construct these leaf conditions or expressions using the GUI by specifying the left operand, operator, and right operand.

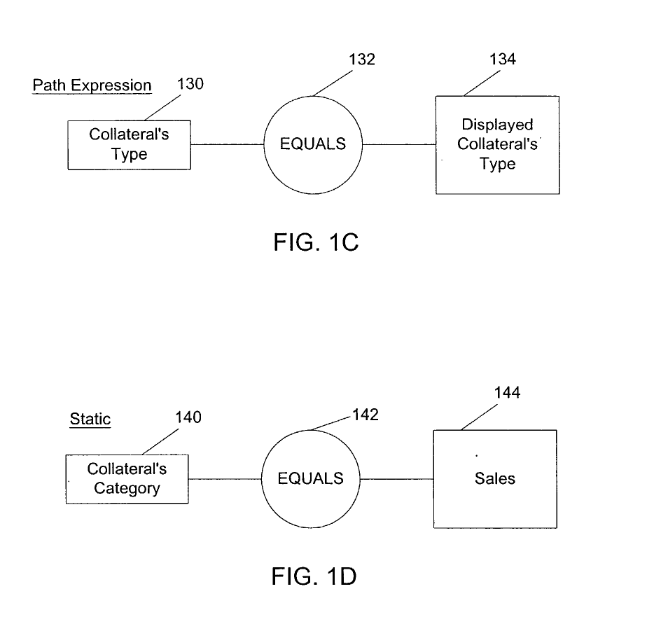

FIG. 2 next shows certain representative GUI screens for managing (i.e., creating and searching) Recommended Content (or Dynamic Query). In area 202, the user is provided a dropdown menu to select a content group to define a new recommended content. The user can pick the default content group (as shown) to create a recommended content with any content type. The user would thereafter click on the defined “create” button. The content group is a logical grouping of business objects available for construction of a query.

In area 204, the user is provided fields in which to specify criteria to search for recommended content. Such criteria might include keywords, locale, displayed content type, and content group. The user might also check boxes to specify query attributes (name and/or description) to search for entered keywords. Thereafter the user clicks on the defined “search” button.

In area 206, the recommended content listing shows the name, content type, content group, and actions pertaining to the created listings. The two examples shown include (a) Name=Collaterals related to displayed collateral; Content type=Collaterals; Content Group=Marketing Collateral; with action icons including (for instance) edit and copy. (b) Name=Cross Sell Product; Content type=Product; Content Group=Catalog, Order and Auction, with action icons including (for instance) edit, copy, and delete. The name is a helper link for query details.

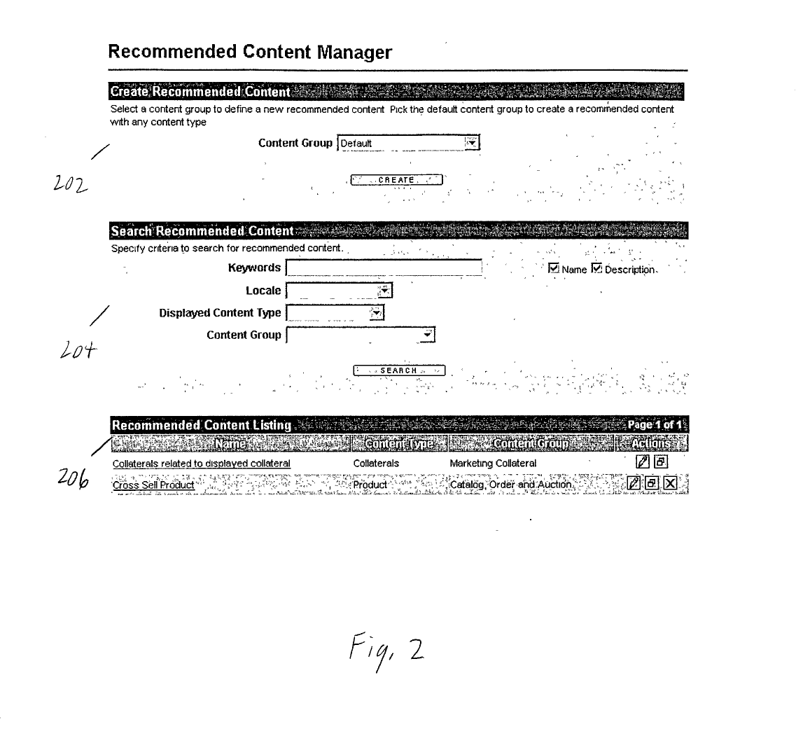

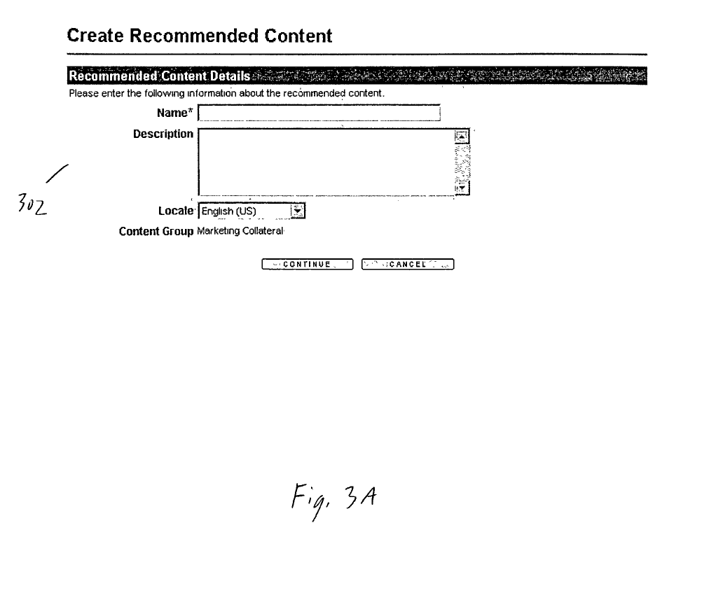

FIG. 3A next shows a first representative GUI screen 302 for creating a query. The user is prompted to enter certain relevant details about the recommended content. Such details might include name, description, and locale. The displayed content group is the one previously selected. The user can continue or cancel this operation via the appropriate buttons.

FIG. 3B shows a next entry screen 304 for entering query attributes. The user is prompted to enter certain values for content creation through a query execution. The values might include displayed content type, maximum number of items, randomization of content, and indications of which fields to sort by. Clicking the save button will include all content of the specified type. Clicking continue will cause screens to appear for adding further conditions.

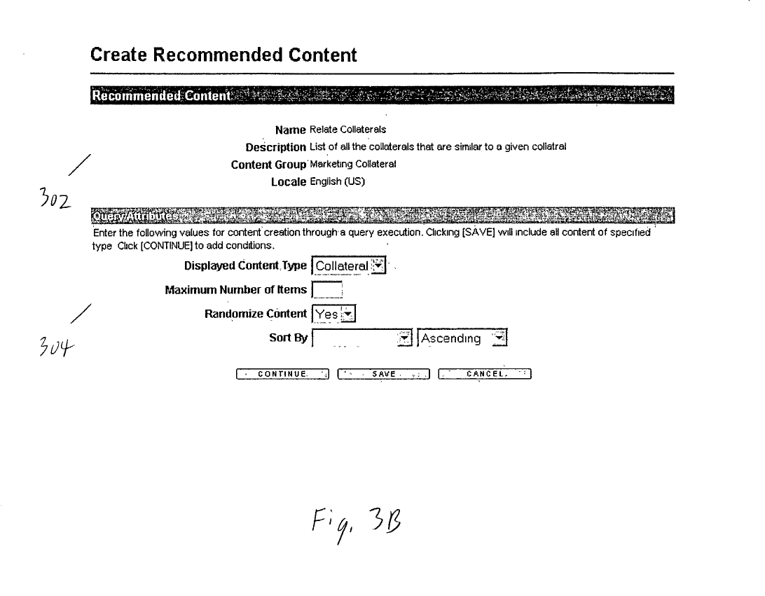

FIG. 4 next shows a representative screen 402 for adding any number of conditions. The user is prompted to first enter the left operand. Then the user selects the operator (i.e. “contains”). The user then specifies the right operand. Choosing the operand type “Defined Object” will imply a “join” (see above) with the defined object of the left operand. The value for the displayed object and attribute will be available at run time. If “Static Value” is selected a operand type, a text box would appear as the right operand. Thereafter, the user clicks on the “Add” button to add the conditions. If no conditions have been added, and if the creator saves the query, then all business objects of the type specified in the previous screen (i.e., Displayed Content Type) would be returned (or included). There are many checks that are done before and after creating a condition. Most of these pull-downs are “Submit-On-Change” i.e. when a value is changed on the screen, other options gets updated automatically. For example if a user selects a different Defined Object, the pull-down menu for “Attribute” would be changed to reflect that. Type checking ensures only operators compatible with the operands are available for condition creation.

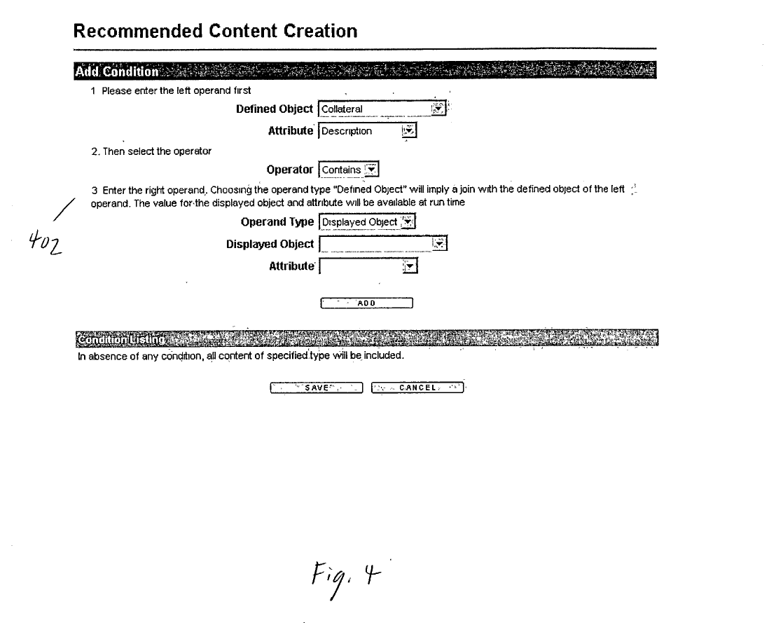

FIG. 5 next shows the representative GUI screen 502 for adding the first condition. As shown, the user first enters the left operand. Second, the user selects the operator. Third, the user enters the right operand. As similar to screen above, by choosing the operand type “Defined Object”, this will imply a “join” with the defined object of the left operand. The value for the displayed object and attribute will be available at run time. The condition listing 504 shows the condition as “If Collateral Description CONTAINS Displayed Collateral Description.” This condition can be saved or canceled via clicking on the associated buttons.

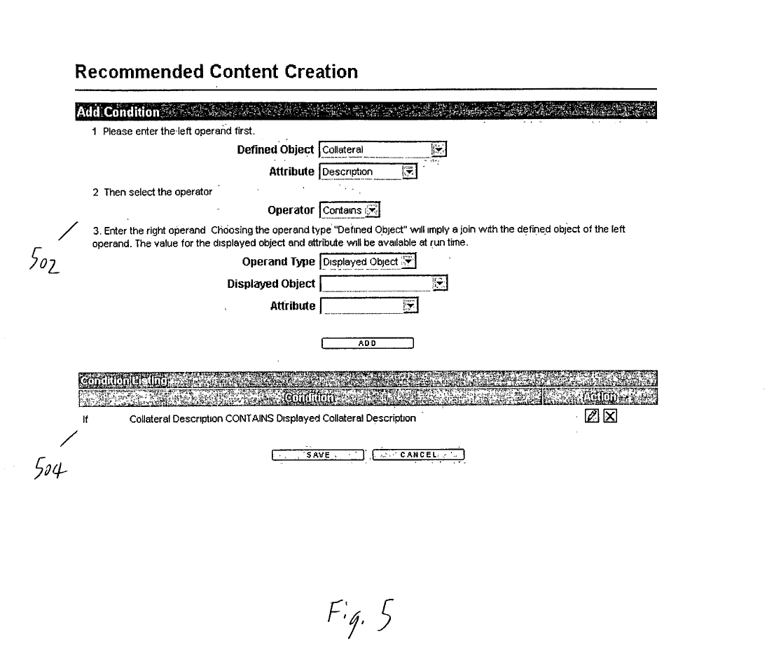

FIG. 6 next shows a representative GUI screen for adding a second condition. The area for adding a condition 602 is similar to the area 502 above. The condition listing 604 shows the two resulting conditions. Whenever there is more than one condition, there is no “save” button below the listed conditions (as above). Instead there are ‘AND’ and ‘OR’ buttons for creation of a complex condition by ANDing or ORing existing conditions. The check-boxes to the left of the “If” statement are used to select each condition that will be included in the complex condition.

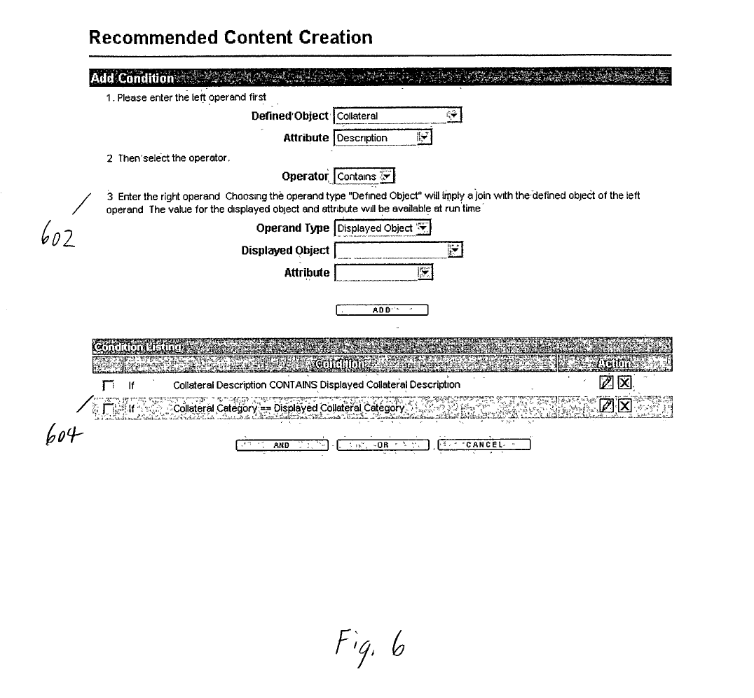

FIG. 7 shows a representative GUI screen 702 for adding a third condition. The condition listing 704 lists the resulting three conditions that have been formed. Accordingly, this is how the three leaf expressions described above are formed. Again, area 704 shows a check-box beside each condition, wherein the condition can be selected and then ANDed or ORed together with the other selected conditions to form a complex condition.

Once the administrator has these three conditions, the administrator can join them in any order, and any number of them using the logical operators ‘AND’ or ‘OR’. For the present example, the administrator will join the second and third expressions to get the following fourth leaf condition in the tree:

4. (Collateral's Category EQUALS Displayed Collateral's Category) OR (Collateral's Type EQUALS Displayed Collateral's Type).

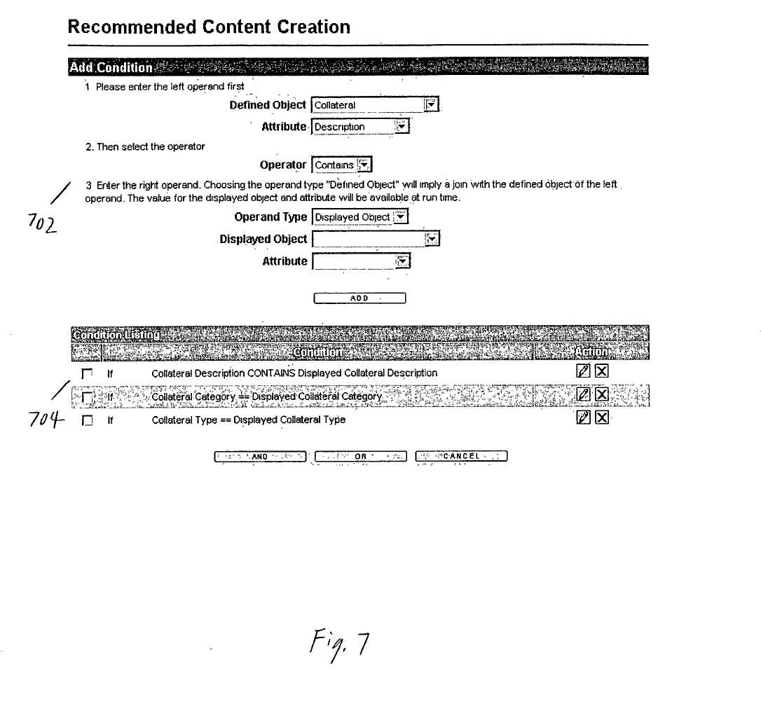

This will result in two conditions 1 and 4. The administrator can split a non-leaf condition (i.e., a condition with more than one expression) at anytime. For instance, the administrator can split condition 4 to get back condition 2 and condition 3. FIG. 8 shows a representative GUI screen 802 with the results of ORing the two conditions from the previous screen. Whenever a condition is made up of more than one expression, a “split” icon 806 appears for reversing the ANDing or ORing of the conditions (i.e., separates out the child conditions).

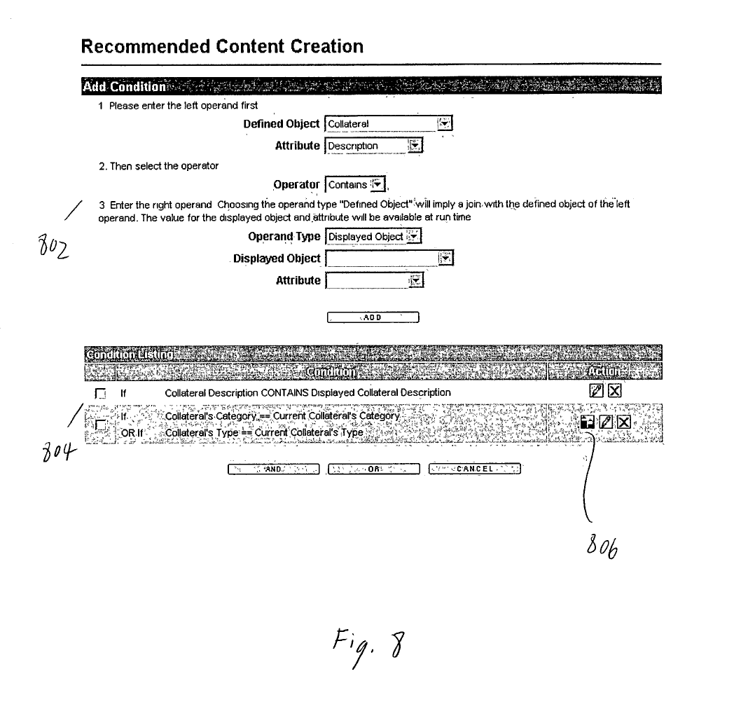

If the edit icon is selected on the previous screen, for instance for the complex condition, then FIG. 9 shows a representative GUI screen 902 for editing any leaf condition. The first step shows a pull-down menu for selecting the individual condition to be edited. The second step shows the pull-down menus for editing the left operand. The third step shows the pull-down menu for editing the operator. The fourth step shows the pull-down menu for editing the right operand. As before, choosing the operand type “Defined Object” will imply a “join” with the defined object of the left operand, with the value for the displayed object and attribute available at run time. One can also specify a static value as the right operand. The user can then click on the button “reset” to clear the fields and start over. Clicking on “done” saves the edited condition. Clicking on “cancel” will cancel the whole editing operation and return to a previous screen. The condition listing area 904 shows yet another different icon 906, which is used to indicate which condition in the listing is currently being edited.

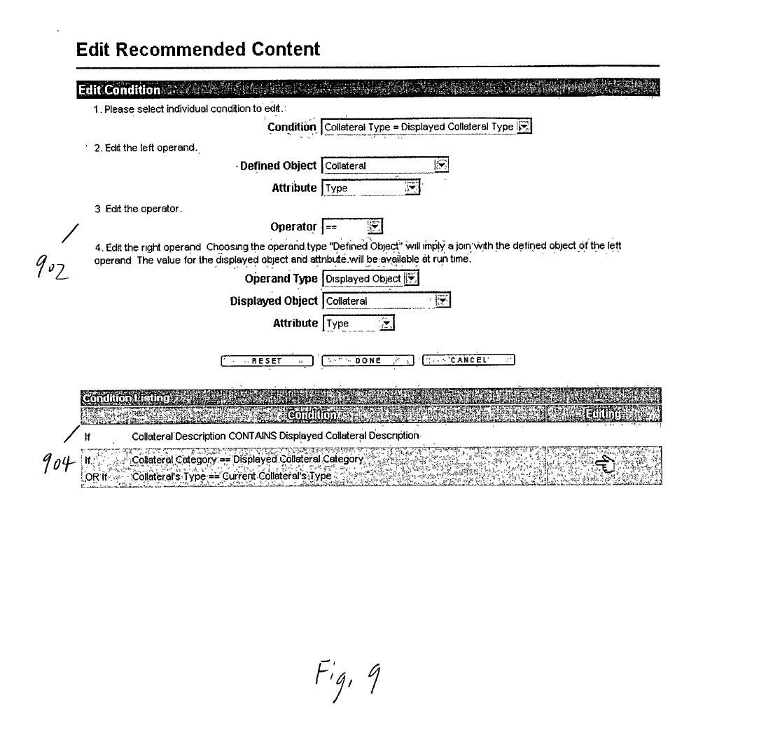

FIG. 10 next shows that by clicking on “done” in FIG. 9, the conditional listing 1002 in the lower part of the screen will reflect the current state of the conditions as arranged by the administrator. The upper part of the screen will return to the “Add Condition” display, wherein more conditions can be added (as needed).

An even more complex condition can be created by clicking a logical operator (AND, OR) button in the condition listing part of the screen. This complex condition becomes the fifth example leaf condition in the tree:

5. (Collateral's Description CONTAINS Displayed Collateral's Description) AND (( Collateral's Category EQUALS Displayed Collateral's Category) OR (Collateral's Type EQUALS Displayed Collateral's Type)).

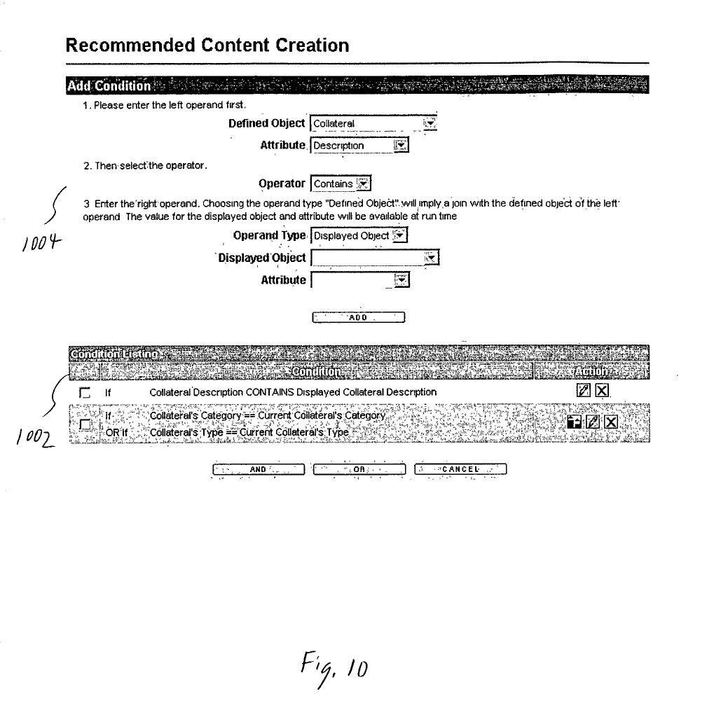

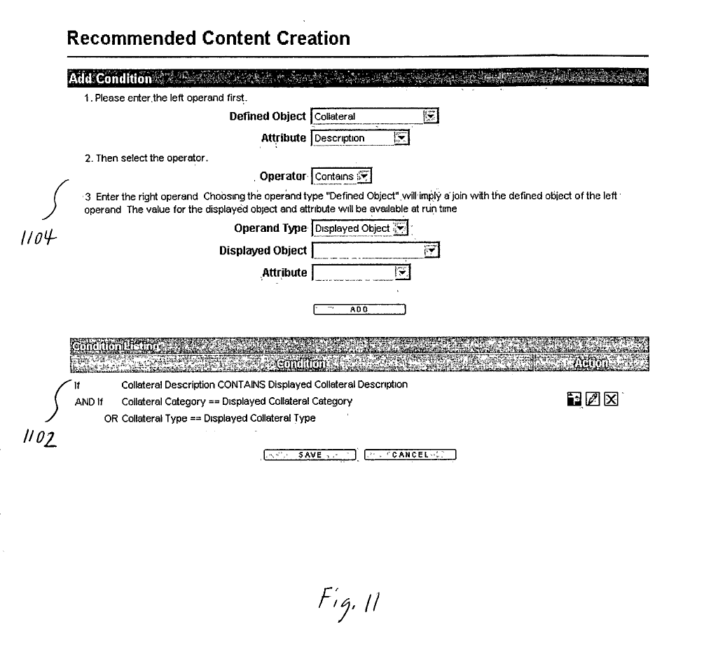

FIG. 11 shows the screen resulting from this operation, wherein the new complex condition is shown in the condition listing 1102 and further conditions can be added via the add condition screen 1104. FIG. 12 shows still another level of complexity in the condition listing 1202. By repeating the process, the user can create more complex conditions. As the level of nesting increases, the condition at a lower level will be parenthesized (for logical convenience). FIG. 11 and FIG. 12 also provides for the ability of the user to save the query in persistent storage once the adding of different leaf conditions has been completed.

This representative GUI for creating the conditions of the Where Clause has certain advantages. It allows for the creation of conditions for the Where Clause in any form. The conditions need not be restricted to any form that imposes restrictions on the level and type of nesting. The conditions are rendered using HTML tables. The GUI then uses parenthesized representations of condition sub-trees at a certain level “N” (where N usually is level 2). If the tree is only N-levels deep, then the GUI will use only the HTML constructs for indentation.

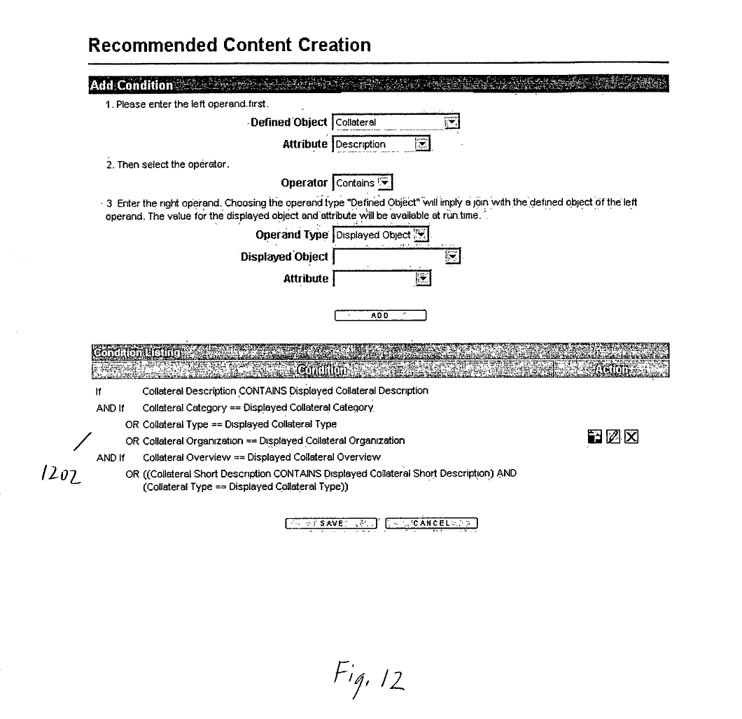

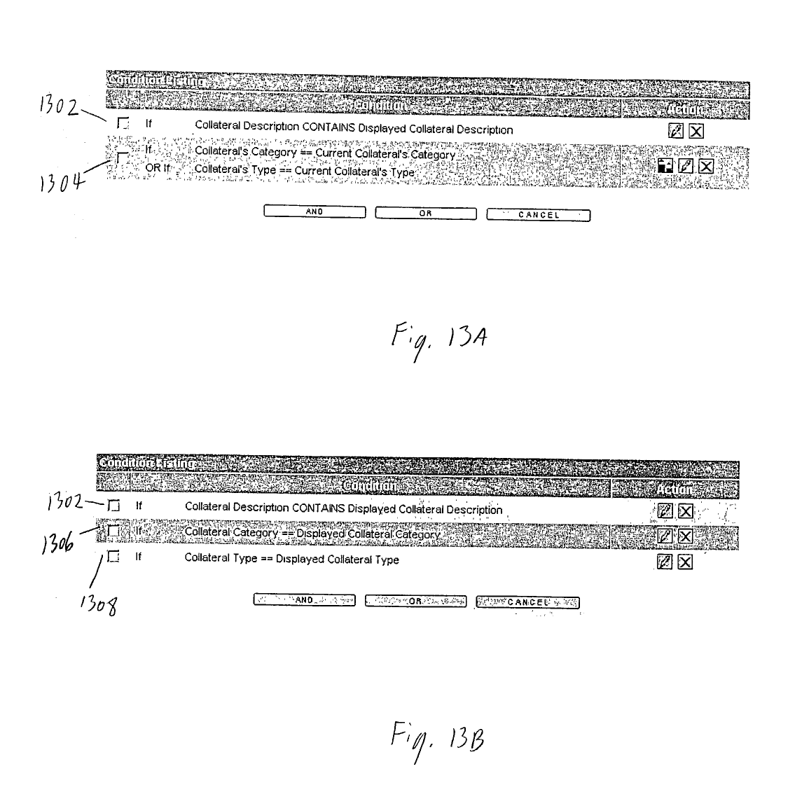

To allow for changing the nesting and joining of conditions, the GUI supports split operations for non-leaf conditions that have more than one expression. This operation is similar to traversing down a tree. For editing conditions (or expressions), the GUI allows a user to pick any one of the leaf-conditions or expressions from a drop-down list for all the expressions in a conditions tree. FIGS. 13A and 13B show the effect of splitting a non-leaf condition. FIG. 13A shows a leaf condition 1302 and a non-leaf condition 1304 that can be split to get back to the sub-trees, which in this case would be the leaf expressions. FIG. 13B then shows the result of splitting the second condition 1304 into the two separate leaf conditions 1306 and 1308.

Certain Java interfaces for constructing the condition tree provides the framework for creating, editing, copying, splitting multiple condition trees, and joining them into one final tree. A recursive definition of criteria elements helps in capturing the way a condition tree is constructed through the GUI (i.e., sequence of joining sub-trees). The present GUI also provides for any level and type of condition nesting. These interfaces, and their implementation are being used for creation of user communities, content conditions in RBP, and the Where Clause of the query in Recommended Content.

Interaction of Recommended Content.

Construction of a Where Clause for recommend content, user community, and content condition for RBP are very similar. All three of these construct an “N-ary” tree of binary expressions through a browser based GUI. The condition tree is then serialized into XML before being stored as one of the business object attributes (i.e., the condition attribute of an Asera business object). For future editing, the tree needs to be reconstructed from this XML. The XML representation will also be evaluated for content condition and user community. The XML representation will also be used to create a query object for recommended content. Java API's can be provided as public API's for all three components to invoke.

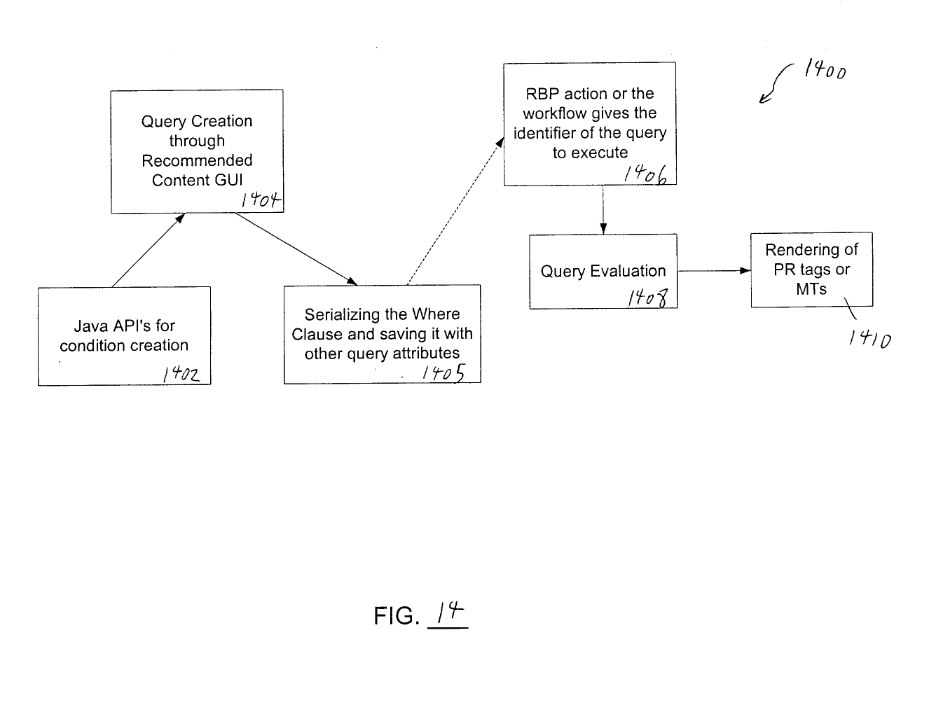

FIG. 14 next shows a representative block diagram 1400, which serves to demonstrate the interaction of the recommended content with other elements in the system. Initially, the conditions are created in block 1402, using Java Interfaces (API's) or the like. These conditions are then used in block 1404 to create queries through the above-described recommended content GUI. After the query has been created, the Where Clause is serialized in step 1405, and is saved along with other query attributes. In block 1406, query identifier is either retrieved from some workflow configuration variable (for use in regular workflows) or from RBP action configuration parameters. Block 1408 next shows the step of query evaluation. Once the query is evaluated, step 1410 then shows the rendering via Personalization Rule (PR) tags or Micro-templates (MT) in order to display the results of the query.

Process and Data Flow.

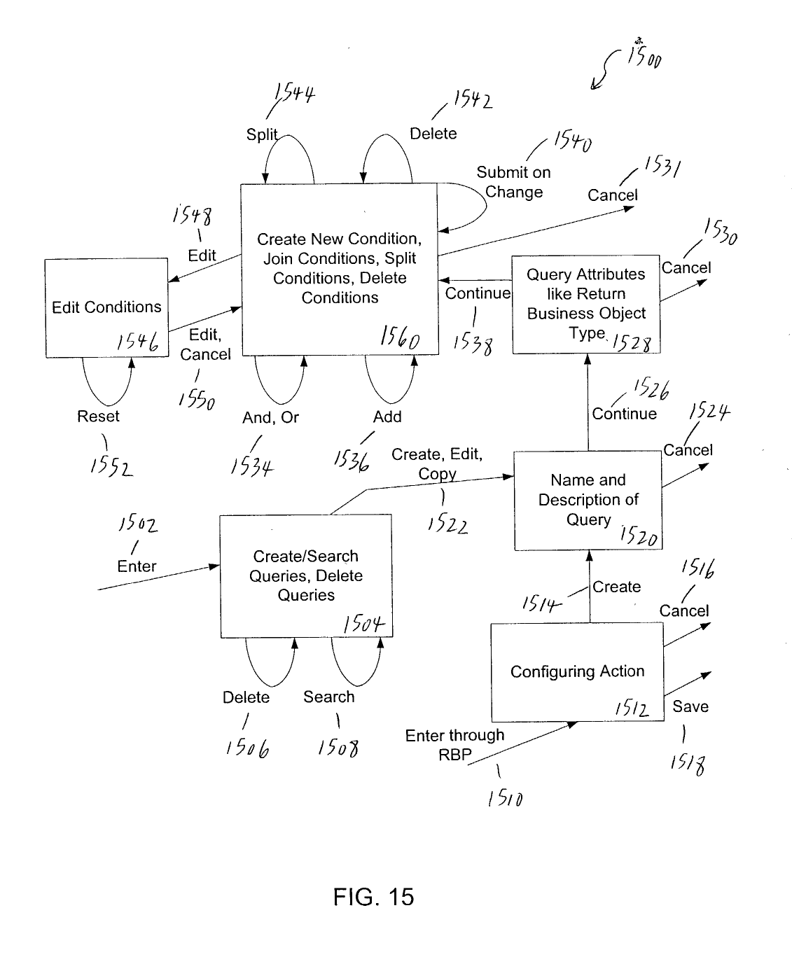

FIG. 15 next shows representative blocks 1500 that represent the process and data flow of the present invention. The process is first shown entering (via 1502) the block 1504 that is used to create/search queries, and to delete queries. The user can loop back around to this process by choosing to delete a query 1506 or search a query 1508. Once completed, the path 1522 will allow the user to create, edit, or copy the query. Block 1520 shows the resulting name and description of the query. The user might also enter through the RBP module 1510. Block 1512 shows the process of configuring a RBP action of type Recommended Content. If create 1514 is chosen, then block 1520 again shows the resulting name and description of the query. The user might also choose to save the query identifier 1518 as RBP action configuration, or cancel the operation 1516.

From block 1520, the user can choose to continue 1526, or cancel 1524 the query creation/editing/copying. Continuing can lead to various things (or information) being created or edited. For instance, block 1528 shows the process of editing or specifying query attributes like the Return Business Object Type. The user can cancel the operation via 1530, or continue via 1538.

Continuing on with the query leads to block 1560 which provides for creating a new condition, joining conditions, splitting conditions, and/or deleting conditions. The associated loops are shown as And, Or (1534), Add (1560), Split (1544), and Delete (1542). If a change is made, then loop 1540 provides for automatic updating of the screen (for example updating available business object attributes when a new business object is chosen for condition creation). Conditions can be edited via connection 1548 to block 1546. An attempt to edit can be reset 1552. The results 1550 of the editing session are then returned to block 1560, or the editing session is cancelled and control also returns back to block 1560.

While the invention has been illustrated and described in detail in the drawings and foregoing description, such illustrations and descriptions are to be considered as exemplary and not restrictive in character, it being understood that only certain embodiment(s) and minor variants thereof have been shown and described, and that all changes and modifications that come within the spirit of the invention are desired to be protected.

1. A method for creating information queries to be used for locating and displaying information from a variety of applications running on a server system, the method comprising:
interactively displaying at least one browser-based graphical user interface screen;
creating at least one condition in response to prompts from the graphical user interface screens;
prompting for the logical combination of the conditions into a query;
prompting for the logical combination of the queries into a complex query;
persisting the resulting query into associated database tables;
executing the query; and
displaying the results of the query to the end user.

2. The method of claim 1, wherein the step of persisting the resulting query includes saving the Where Clause in XML.

3. The method of claim 1 wherein the query includes attributes.

4. The method of claim 3, wherein the step of persisting the resulting query includes serializing the Where Clause and saving it with other query attributes.

5. The method of claim 1, wherein the step of creating at least one condition results in the formation of a plurality of logical trees corresponding to the conditions.

6. The method of claim 5, wherein the logical trees are comprised of leaf conditions having one expression, and non-leaf conditions having more than one expression.

7. The method of claim 5, wherein leaf conditions can be combined into non-leaf conditions.

8. The method of claim 6, wherein non-leaf conditions can be split back into leaf conditions.

9. The method of claim 4, wherein the plurality of logical trees are combined into one tree using logical operators.

10. The method of claim 1, wherein the step of executing the query includes executing the query using a query-adapter framework.

11. The method of claim 10, wherein the adapter-connector framework includes the Asera adapter-connector framework.

12. The method of claim 1, wherein the step of displaying the results includes rendering of personalization rule (PR) tags.

13. The method of claim 1, wherein the step of displaying the results includes rendering of micro-templates.

14. A graphical user interface that provides for creating the conditions for a Where Clause of a query in any form, the interface comprising:
at least one interactive screen to allow the user to select query leaf conditions;
at least one interactive screen to allow the user to logically nest and join query leaf conditions;
at least one interactive screen to allow the user to change the nesting and joining of query leaf conditions; and
at least one interactive screen to allow the user to repeat certain screens, thereby adding more leaf conditions, and joining them into a more complex condition,
whereby the resulting query is saved in a persistent storage for execution of the query, and for display of the query results.

15. The graphical user interface of claim 14, wherein the Where Clause is serialized into an extensible markup language (XML) construct.

16. The graphical user interface of claim 14, wherein the conditions are rendered using HTML tables.

17. The graphical user interface of claim 14, wherein the conditions exist as trees which are grouped into sub-tree levels, and use parenthesized representation for condition sub-trees at a certain level N.

18. The graphical user interface of claim 17, wherein a tree that is only N levels deep uses HTML constructs for indentation.

19. The graphical user interface of claim 17, wherein N is 2.

20. The graphical user interface of claim 14, wherein the interactive screens are browser based.
